(19) United States
(12) Patent Application Publication
(10) Pub. No.: US 2020/0265539 A1
(43) Pub. Date: Aug. 20, 2020

(54) OFF-DUTY POLICE SCHEDULING SYSTEM AND METHOD

(71) Applicant: OFF DUTY FORCE LLC, ALBUQUERQUE, NM (US)

(72) Inventors: Rockwell Allen Morris, Orange Park, FL (US); David Dickson, Orange Park, FL (US); John Dean, Jacksonville, FL (US)

(73) Assignee: Off Duty Force, LLC, ALBUQUERQUE, NM (US)

(21) Appl. No.: 16/281,071

(22) Filed: Feb. 20, 2019

(51) Int. Cl. G06Q 50/26; G06Q 10/06; G06Q 10/10

(52) U.S. Cl. CPC G06Q 50/26; G06Q 10/1091; G06Q 10/063116

(57) ABSTRACT

An off-duty scheduling system for police officers automatically generates a list of qualified available officers. Filtering eliminates, from the candidate pool, officers lacking requisite training or credentials, officers who have reached or exceeded off-duty work limits, and inactive officers. Multi-level sorting arranges the candidate pool in order of priority based upon specified criteria, such as, time from last off-duty assignment and seniority. Officers are invited to perform the job, until the job is fully staffed. Start and end of job performance are tracked and reported, with payments made automatically upon completion.

### FIELD OF THE INVENTION

This invention relates generally to scheduling and compensating off-duty police for services.

### BACKGROUND

Every day, law enforcement officers across the country don their uniforms, strap on their gun belts, and head to work. They carry the equipment and weapons they have been issued and bear the badges that symbolize their authority, but they are not all reporting to the government agency that employs them. Instead, many are “moonlighting,” engaging in “extra-duty” employment. From directing traffic at a busy church parking lot to providing security at a private event, off-duty officers exercise the full panoply of police powers while working for private employers.

Heretofore, the process of selecting officers and providing compensation for their extra-duty service has been handled on an ad hoc basis. Generally, requests for extra-duty employment (i.e., employment conditioned on the actual or potential use of law enforcement powers) are sent from businesses and other organizations to a designated person or office within a police department. Notices may be posted on a physical or online bulletin board announcing the employment request. Available officers who are interested may then sign up for the detail. Sometimes a modicum of effort is made to award jobs to officers with seniority, and/or with applicable skills and certifications, and/or who are next in a rotation. Selected officers are then advised about nature of work, dress (uniform or plain clothes), contact person and where they should report.

In some jurisdictions, the hiring party pays the department for the officer's services, who in turn pays the officer. In other jurisdictions, the officer is paid directly. Amounts paid and to whom depend upon time duration of service, whether a department vehicle or other department equipment and resources are used on the job, and department policies.

Problems with such systems are legion. Many available officers are overlooked. Unqualified officers may be assigned to tasks they should not perform. Some officers may receive preferential treatment, being offered the more highly coveted jobs. The department may not receive adequate compensation for all assignments. Customers may overpay or underpay due to lax timekeeping and mileage reporting. Payment may be delayed due to tardy reporting.

The invention is directed to overcoming one or more of the problems and solving one or more of the needs as set forth above.

### SUMMARY OF THE INVENTION

To solve one or more of the problems set forth above, in an exemplary implementation of the invention, an improved off-duty scheduling method and system for police officers automatically generates a list of qualified available officers, which may be sorted according to priority and time from last off-duty assignment. Filtering eliminates, from the candidate pool, officers lacking requisite training or credentials, officers who have reached or exceeded off-duty work limits, and inactive officers. Multi-level sorting arranges the candidate pool in order of priority based upon specified criteria, such as, time from last off-duty assignment and seniority. The filtered and sorted data comprises a list or table. One or more officers are invited to perform the job, until the job is fully staffed by one or more invited officers accepting the invitation. The system eliminates bias in assigning off-duty jobs. The system accurately tracks time and mileage for accurate payment computation. Payments are made for completed jobs, according to department policy. The system also facilitates the hiring of off-duty officers, making such talent accessible to businesses and organizations who might not otherwise navigate the departmental policies and procedures for making such hires. Concomitantly, the system expands opportunities for supplemental income to police officers.

An exemplary computer implemented method for managing off-duty jobs for officers includes a step of receiving on a first computing system, from a second computing device, a job posting for an off-duty job from a customer. Upon receiving the job posting, the first computing system automatically accesses a database. The database contains a plurality of records including a record for each officer eligible for off-duty work. After accessing the database, the first computing system automatically applies a first filter to exclude at least one record for an officer eligible for off-duty work. The first computing system also automatically applies a multi-level sort to sort the plurality of records, excluding each excluded record, in a determined order. The determined order spans in progression from a first record for an officer eligible for off-duty work, to a last record for another officer eligible for off-duty work. The first computing system automatically communicates, via network communication, to a third computing device, an invitation to the officer eligible for off-duty work corresponding to the first record. The invitation is an invitation to perform the off-duty job.

Each record includes a plurality of fields, the plurality of fields include an identifier for an officer eligible for off-duty work, a rank for the officer eligible for off-duty work, a seniority indicator for the officer eligible for off-duty work. Another field is a total hours worked quantity for off-duty jobs worked by the officer eligible for off-duty work during a determined period of time. Another field is an indicator of the time to a preceding off-duty job worked by the officer eligible for off-duty work.

The filter may exclude any record having a rank that is a determined rank, any record for which the total hours worked quantity is not less than a determined limit and/or any record in which the indicator of the time to a preceding off-duty job worked by the officer eligible for off-duty work is not greater than a determined limit.

A multi-level sort entails automatically sorting records by at least two sort levels (e.g., 2 or 3), the sort levels include at least two of the following rank, the total hours worked quantity, and the indicator of the time to a preceding off-duty job worked by the officer eligible for off-duty work. The sorts may be conducted in any order, ascending or descending. The sort order may be specified by the department. By way of example, the three sort levels may include the following sorts in the an order determined by input from the second computing device: first, the rank sorted in descending order; second, the total hours worked quantity sorted in ascending order; and third, the indicator of the time to a preceding off-duty job worked by the officer eligible for off-duty work sorted in descending order. Alternatively, as another example, the following sort order may apply: first, the indicator of the time to a preceding off-duty job worked by the officer eligible for off-duty work sorted in descending order; second, the total hours worked quantity sorted in ascending order; and third, the rank sorted in descending order.

The first computing system may receiving via network communication from the third computing device a reply to the invitation. The reply may be an acceptance or rejection of the invitation. If a reply is not received within a determined time frame (a determinmed delay), the first computing system treats the invitaation as rejected. If accepted, the first computing system sends a reminder to the third computing device a reminder of the off-duty job. If rejected, the next officer corresponding to the second record in the sort results is invited. This entails the first computing system automatically communicating, via network communication, to a fourth computing device, an invitation to the officer eligible for off-duty work corresponding to a second record.

When an officer begins to perform a job and completes perfroming a job, the officer, via the third ccomputing device, sends time stamped start and end communications. The first computing system automatically receives, via network communication, from the third computing device, a start communication from the officer eligible for off-duty work corresponding to the first record, the start communication being time stamped and indicating that the officer has begun to perform the off-duty job. The first computing system also automatically receives, via network communication, from the third computing device, an end communication from the officer eligible for off-duty work corresponding to the first record, the end communication being time stamped and indicating that the officer has ceased to perform the off-duty job.

Based upon the start and end communications and whether a department vehicle is used, the first computing system automatically determines payments. An amount may be paid to the officer for performing the off-duty job. An amount may be paid to the officer's department for use of the official vehicle.

Reports are also provided. The first computing system may automatically communicate a report to the third computing device. The first computing system may also automatically communicate a report to a computing device of a department employing the officer.

### BRIEF DESCRIPTION OF THE DRAWINGS

The foregoing and other aspects, objects, features and advantages of the invention will become better understood with reference to the following description, appended claims, and accompanying drawings, where:

FIG. 1 is a high level block diagram illustrating components of an exemplary scheduling system according to principles of the invention; and

FIG. 2 is a high level flowchart illustrating steps of an exemplary scheduling methodology for an exemplary system according to principles of the invention; and

FIG. 3 is another high level flowchart illustrating steps of an exemplary scheduling methodology for an exemplary system according to principles of the invention; and

FIG. 4 is a table illustrating a candidate pool prior to sorting according to principles of the invention; and

FIG. 5 is another high level flowchart illustrating steps of an exemplary scheduling methodology for an exemplary system according to principles of the invention; and

FIG. 6 is another high level flowchart illustrating steps of an exemplary scheduling methodology for an exemplary system according to principles of the invention; and

FIG. 7 is another high level flowchart illustrating steps of an exemplary scheduling methodology for an exemplary system according to principles of the invention; and

FIG. 8 is another high level flowchart illustrating steps of an exemplary scheduling methodology for an exemplary system according to principles of the invention; and

FIG. 9 is another high level flowchart illustrating steps of an exemplary scheduling methodology for an exemplary system according to principles of the invention.

Those skilled in the art will appreciate that the figures are not intended to illustrate every embodiment of the invention. The invention is not limited to the exemplary implementations depicted in the figures or the specific components, configurations, steps, or order of steps as shown in the figures. The text assigned to flowchart steps and block diagram elements are provided for reference purposes and not intended to limit any such element, step or the invention.

### DETAILED DESCRIPTION

In an exemplary implementation of the invention, an improved off-duty scheduling method and system for police officers automatically generates a list of qualified available officers. The list is generated from a database of officers. Filtering eliminates, from the candidate pool, officers lacking requisite training or credentials, officers who have reached or exceeded off-duty work limits, and inactive officers. Multi-level sorting arranges the candidate pool in order of priority based upon specified criteria, such as, time from last off-duty assignment and seniority. The filtered and sorted data comprises a list or table. One or more officers are invited to perform the job, until the job is fully staffed by one or more invited officers accepting the invitation. Invitations are extended according to the sorted order, thus the system eliminates bias in assigning off-duty jobs. The system accurately tracks time and mileage for accurate payment computation. Payments are made for completed jobs, according to department policy. By facilitating hiring of off-duty officers, the system makes such talent accessible to businesses and organizations that might not otherwise navigate the departmental policies and procedures for making such hires. Concomitantly, the system expands opportunities for supplemental income to police officers.

An implementation of the present invention may be embodied in hardware and/or in software (including firmware, resident software, micro-code, etc.). Furthermore, the present invention may take the form of one or more computer program products on one or more computer-usable or computer-readable storage media having computer-usable or computer-readable program code embodied in the media for use by or in connection with an instruction execution system. A computer-usable or computer-readable medium may be any medium that can contain, store, communicate, propagate, or transport the program for use by or in connection with the instruction execution system, apparatus, or device. The computer-usable or computer-readable medium may be, for example but not limited to, an electronic, magnetic, optical, electromagnetic, infrared, or semiconductor system, apparatus, device, or propagation medium. More specific non-limiting examples (a non-exhaustive list) of a computer-readable medium include random access memory (RAM), a read-only memory (ROM), an erasable programmable read-only memory (EPROM or Flash memory), a hard disk drive, a solid state drive, a portable compact disc read-only memory (CD-ROM), a Blu-ray disc (BD).

Computer program code or “code” for carrying out operations (e.g., steps) according to the present invention may be written in any programming language compatible with the corresponding computing devices and operating systems. Software embodiments of the present invention do not depend on implementation with a particular programming language.

The computer program code may be provided to a processor of a general-purpose computer, special purpose computer, or other programmable computing apparatus (e.g., a phone, personal digital assistant, tablet, laptop, personal computer, or computer server) as instructions to produce a machine, such that the instructions, which execute via the processor of the computer or other programmable data processing apparatus, create means for implementing the functions specified in the illustrations. The computer code may be stored in a computer-readable memory that can direct a computer or other programmable data processing apparatus to function in a particular manner, such that the instructions stored in the computer-readable memory produce an article of manufacture including instruction means which implement the functions and perform the steps specified in the illustrations and described herein.

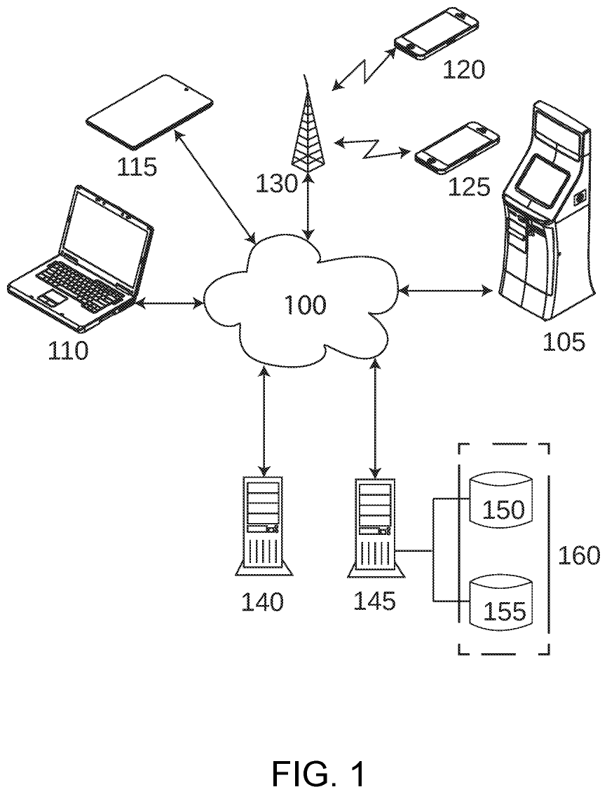

Referring now to FIG. 1, a high level block diagram of hardware components of a system according to principle of the invention is conceptually illustrated. Consistent with the present invention, users of the system use computing devices, such as smart phones 120, 125, a tablet 115, a laptop computer 110, a kiosk 105, or a personal computer 140, communicating in a wireless or wired mode via a network, such as the Internet 100. The computing devices (i.e., clients or client devices) are equipped with software for inputting and displaying information in accordance with the methodologies described herein. Such software may comprise a web browser and/or a mobile device app. Some of the computing devices 120, 125 may be equipped with cellular wireless communication modules providing internet access via wireless cellular communication infrastructure 130.

The term “service provider” is used herein to mean any entity that provides a service using a system or methodology according to principles of the invention. The service provider may be, for example, an online service provider with a web-accessible system that receives and processes job postings from businesses or organizations according to principles of the invention. A service provider may also be one or more departments or agencies, as described below.

The terms “officer” and “candidate” are used interchangeably herein to mean any individual whose information (identity, contact information, and other relevant information) has been provided to the system for job assignments. The information may be entered or uploaded to the system or made accessible to the system via a network connection. As used herein, officers or candidates may be police officers or other police personnel, military personnel (regardless of rank), and private security personnel.

The terms “department” and “agency” are used interchangeably herein to refer to the regular employer of officers. The department or agency may be any law enforcement, security or defense organization that allows its personnel to take off-duty job assignments (i.e., to moonlight). A department or agency may be a police office, a government entity, a quasi-government entity or a security business.

The term “hiring party” is the business or organization seeking to hire one or more officers for a job. Nonlimiting examples of hiring parties are churches, special event organizers, sporting and entertainment venues, and private businesses in need of security and/or crowd or traffic control.

The service provider's computing system includes a server 145 (e.g., web server) accessible via a network such as the Internet 100. The server 145 is communicatively coupled to one or more databases 150, 155 and operates a database management system (DBMS) that stores, updates, sorts, filters, queries and analyzes structured data in the one or more databases 150, 155, and produces reports and output based on the data. The databases 150, 155 may be resident on or local to the server 145, or remote from the server 145, hosted by a third party and accessible via the Internet 100. Collectively, the databases are referred to as a database 160.

Using a computing device 105-125 and client software (“client”) such as a browser or app, a hiring party may create a job posting. A job posting specifies the hiring party, location, dates, times, services to be provided, attire (e.g., uniformed or plain clothes), vehicle (official vehicle or not), armed status (i.e., whether a firearm is required), an expiration date, number of officers required, and other particulars. A user may input data pertaining to the job posting using a database form. The form is an object, window or screen that contains fields and controls to enter data and make data selections. Data from the form is entered into one or more tables of the database 160.

When a job posting is created, the information is entered as a record in one or more tables of the database 160. A default status of active is associated with the newly created posting. The status of a job posting remains active until hiring is completed, the posting expires or the posting is canceled. The status of the job posting changes to closed when hiring is completed, the posting expires or the posting is canceled.

Using another computing device (e.g., 140) and client software, a department may either provides personnel data for the database 160 or access to personnel data. The personnel data includes officers' names, work address, contact information, certifications, rank, work status (e.g., active, disabled, suspended, etc. . . . ), hourly rate, and total hours worked off-duty. Alternatively or additionally, personnel who are interested in off-duty work may be invited to input their own information using a network accessible form for data entry. Data provided for each individual may comprise one or more records in one or more tables in the database 160. Each such record is associated with a record for the department that regularly employs the officer.

Additionally, using a computing device (e.g., 140) and client software, a department may provide information about the department and related to department policies and procedures. Information about the department may include name, address, contact information, account information for providing payment. Information related to department policies and procedures may include payment procedures (e.g., pay all amounts to the department, which will then pay personnel; or pay personnel for his/her service, and pay the department for vehicle and/or equipment use). Such information may also include department limits on hours of off-duty work per officer, types of jobs for which officers may be hired, and rates for use of a vehicle or equipment (e.g., mileage rates and/or hourly rates for vehicle use). Data provided for the department may comprise one or more records in one or more tables in the database 160.

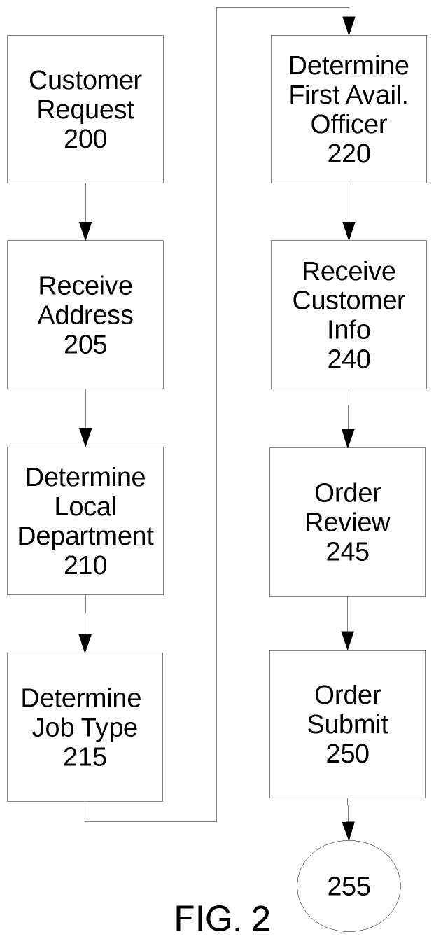

FIG. 2 provides a high level flowchart illustrating steps of an exemplary scheduling methodology for an exemplary system according to principles of the invention. In step 200, a hiring party (customer) submits a request to the system for one or more officers to provide a service on a specified day (or days) at a specified time (or times) for a specified duration. The request may be for a single instance, several instances or a recurring job.

An address for the location of the job to be performed is provided to the system, as in step 205. Based upon the address, the system identifies one or more local departments, as in step 210.

The hiring party also enters a description of the service required, as in step 215. The service is one that is suitable for performance by an officer, such as, but not limited to, security, crowd control or traffic control. The description information may specify whether an official vehicle or firearm is required and whether the officer must wear an official uniform, the hiring party's uniform, some other attire or plain clothes.

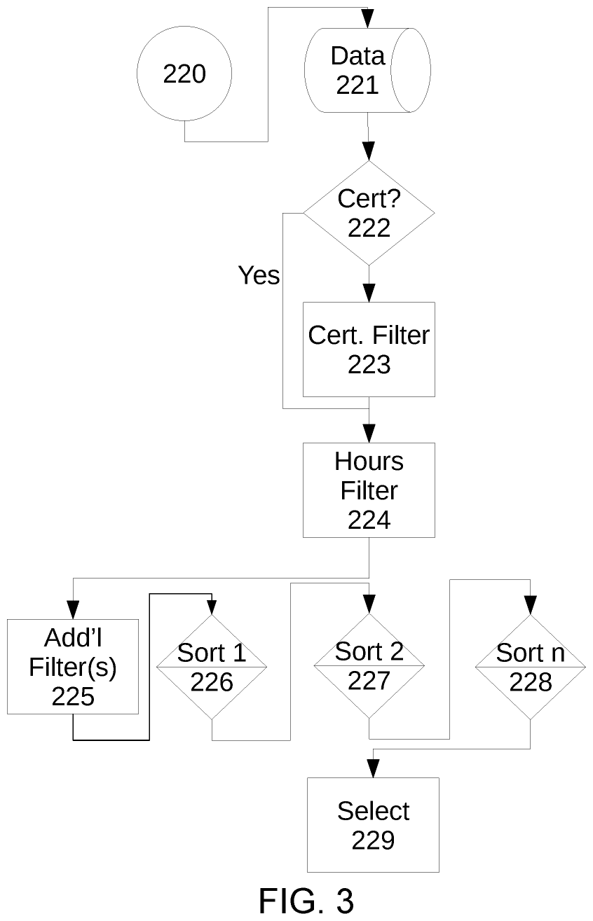

After the location and type of service are determined, a process may be performed to determine the officer(s) to invite to perform the service, as in step 220. This process is described below in greater detail with reference to FIG. 3. At this stage available officers have been identified, but have not yet been notified of the off-duty job opportunity and have not yet been invited to provide the requested service.

Customer information for the hiring party may have been previously entered into the system, such as during an online registration process. Such information may include the hiring party's name, address, contact information and other particulars. The system may ask the hiring party to enter the information, if any is missing, or to confirm that any previously entered information is still correct, as in step 240.

Based upon the customer's input, the system generates an order for review by the customer, as in step 245. This step may be performed before or after step 220. The order will specify information related to the request, such as the service, dates, times, location, number of officers requested, and actual or approximate fees. The customer may have an opportunity to make corrections or changes to the order, before it is submitted. If no further changes are necessary, the customer may submit the order, as in step 250. Submission may entail selecting a submit order control.

FIG. 3 is a high level flowchart illustrating steps of an exemplary selection methodology for a scheduling system according to principles of the invention. The selection may be performed before or after order submission. Performing selection before order submission is advantageous for determining if any officers are available before an order is submitted.

A data source (e.g., local or remote database) that contains available officer information is accessed in step 221. Next, a determination is made if the job requires a certification, as in step 222. Certain jobs may, according to applicable law, department policy or industry standards, require special training and certification. If a certification is required, then all officers lacking the requisite certification are omitted from the pool of candidates. Officers that lack a required certification for the off-duty job are filtered from the pool of candidates in step 223. The pool of candidates that remain after the filtering step 223 may be written to a list or table.

The system also determines if an officer has exceeded off-duty work limits or will exceed any such limits by taking the job. A department may specify a limit. By way of example and not limitation, a department may limit such work to 10 hours per week, or 40 hours per month or 120 hours per quarter, or 520 hours per year. Each officer's cumulative total off-duty hours worked for a period (e.g., month, quarter or year) is entered into and tracked by the system. As an officer completes a job, the total for that officer is updated to reflect the completed hours worked. Officers that have exceeded or will, by taking the job, exceed the department's off-duty hourly limits are filtered from the pool of candidates in step 224. The pool of candidates that remain after the filtering step 224 may be written to a list or table. One or more candidates for the job will be determined from this pool of candidates.

In steps 225-228, a customizable multi-level filtering and sorting method arranges the pool of candidates in an order to extend invitations. The first candidate in the order will be the first to invite to provide the service. The second candidate in the order will be the second to invite to provide the service, which may be necessary if the first candidate declines or the service requires several officers. The third and subsequent candidates will be invited, in turn, as needed to fulfill the order.

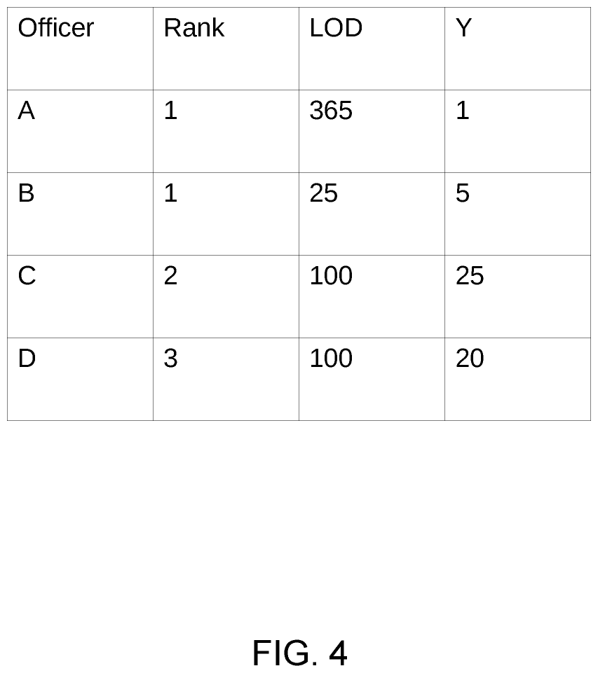

The filtering and sorting method is customizable. A database or table of available officers may contain several columns, as conceptually illustrated in FIG. 4. Each column is a set of data values of a particular type, one value for each row of the database or table. A column may contain text values, numbers, or even pointers to data or files in the system. Each row is a record that corresponds to a particular officer.

Filtered and sorted results are provided in a table stored in memory and/or as a file on a data storage device. Such storage may be temporary, for an active session. Filtering entails excluding, from the table, one or more rows based upon a defined filter. Sorting entails arranging the rows (i.e., records) in the table in a certain order. The system uses the filtered and sorted table (i.e., the candidate pool) to determine the order in which officers in the candidate pool are invited.

In the nonlimiting example of FIG. 4, 4 rows and columns of data are provided. The first column is an identifier (e.g., name or badge or id no.) for each officer. In the example, the officers are named A, B. C, and D. The second column is an indicator of rank, with higher numbers designating higher ranks. The third column indicates the time (in days) from each officer's last off-duty job. In the example, the values range from a low of 25 days for officer B to a high of 365 days for officer A. The last column indicates years of service as an officer (i.e., seniority), with officer C having 25 years of service and officer A having 1 year of service.

A department may select the columns (i.e., criteria) by which to sort, the sort order for each column (ascending or descending), and the order in which the multi-level sorting is performed. These parameters provide considerable flexibility in customizing the system to invite qualified candidates for off-duty jobs in a consistent and objective manner according to department preferences. The parameters may be specified by a department in a filtering and sorting form.

A department may also specify filters. Each filter specified by a department indicates the column that contains the data subject to the filter, a value and a relation. The relation may be one of equal (=), greater than (>), less than (<), equal or greater than (≥), or equal or less than (≤). Using filters, a department may omit, from a candidate pool, any officer that has a value in a filtered column that is excluded by operation of the filter.

Multiple filters may be applied to one column. For example, one filter may exclude any row for which a value in the filtered column exceeds a department-set value. Another filter may exclude any row for which a value in that same filtered column falls below another department-set value. Yet another filter may exclude any row for which a value in that same filtered column equals another department-set value.

If a department does not set sorting or filtering parameters, default sorting and filtering parameters may apply. The default parameters may be set by a system administrator. A department may set and subsequently change the parameters, as the department desires.

As a nonlimiting sorting example, one department may prefer extending off-duty job offers to highest ranking officers, the most senior officers and those who are next in a rotation. In the example of FIG. 4, sorting according to rank, then seniority and then LOD would place the officers in this order: D, C, B, A. D would come first because D has the highest rank. C comes second because C has the next highest rank. B comes before A because B has greater seniority. To achieve such ordering, the multilevel sorting may include first level sorting by rank (in descending order) in step 226, second level sorting by seniority (in descending order) in step 227, and third level sorting by time from last off-duty job (in descending order) in step 228.

Another department may prefer to extend off-duty job offers to those who are next in a rotation, lowest ranking officers, the most senior officers. To achieve such ordering, the multilevel sorting may include first level sorting by time from last off-duty job (in descending order) in step 226, second level sorting by rank (in ascending order) in step 227, and third level sorting by seniority (in descending order) in step 228. This is another nonlimiting example of an implementation of the filtering and sorting method.

As part of the filtering and sorting method, a department may also choose to filter out officers according to certain criteria, as in step 225. By way of example and not limitation, a department may want to exclude from the candidate pool officers above or below a particular rank or seniority. This exclusion may be accomplished by additional filtering in step 225. A department may also exclude from the candidate pool any officer that has taken an off-duty job within the past X days (e.g., filter LOD≤30). These are but a few nonlimiting examples.

In sum, the filtering and sorting process of the invention produces an ordered candidate pool in the form of a list or table of available qualified officers. The list or table is ordered according to the department specified (or default) multi-level sorting. The filtering and sorting may be according to department preferences, policies, and/or a collective bargaining agreement with a union.

Filtering and sorting operations may be performed according to any filtering and sorting functions available for the DBMS being used. The filtering function processes a data structure (e.g., a list or a table) to produce a new data structure containing exactly those elements of the original data structure for which a given predicate returns the boolean value true. For example, a filter may be applied to a list to keep all values under 5, thereby eliminating all values that are 5 or greater. The new data structure is a list that excludes all values of 5 or greater. In the case of a table, as in a database in accordance with principles of the invention, the new table excludes each row that contained an excluded value.

In an exemplary implementation, the system does not provide the complete list or table to the customer. Rather, the customer is notified of each invitation (offer) generated by the system in step 270. Preventing customer access to the complete list or table protects officer privacy while reducing risks of discrimination and a customer sidestepping the system and reaching out directly to an officer.

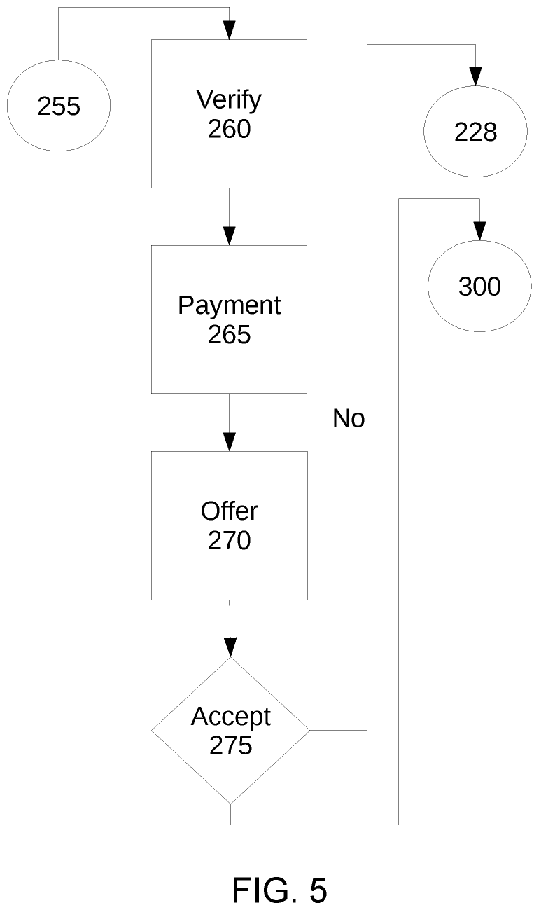

Referring now to FIG. 5 another high level flowchart illustrating steps of an exemplary scheduling methodology for an exemplary system according to principles of the invention is provided. In step 260, the order is cross-referenced with system data to verify policy compliance for job request. This step ensures that the order does not conflict with department policies for hiring off-duty officers.

In step 265, payment is processed. The customer makes payment for the service using a payment portal. The payment portal is a merchant service provided by an e-commerce application service provider that authorizes credit card or direct payments processing. A web browser encrypts the information to be sent between the browser and the merchant's webserver or directly from the customer's browser to a gateway, bypassing the merchant's systems. This reduces the merchant's Payment Card Industry Data Security Standard (PCI DSS) compliance obligations without redirecting the customer away from the website. The payment may include a fee for the online service, a fee for full or partial payment for the service to be provided by the hired officer(s), and a fee for full or partial payment for any amounts due to the department for the hire. If the payment includes a fee for full or partial payment for the service to be provided by the hired officer(s) and/or a fee for full or partial payment for any amounts due to the department for the hire, these amounts may be held in an account (e.g., an escrow account) until the service is rendered by the hired officer.

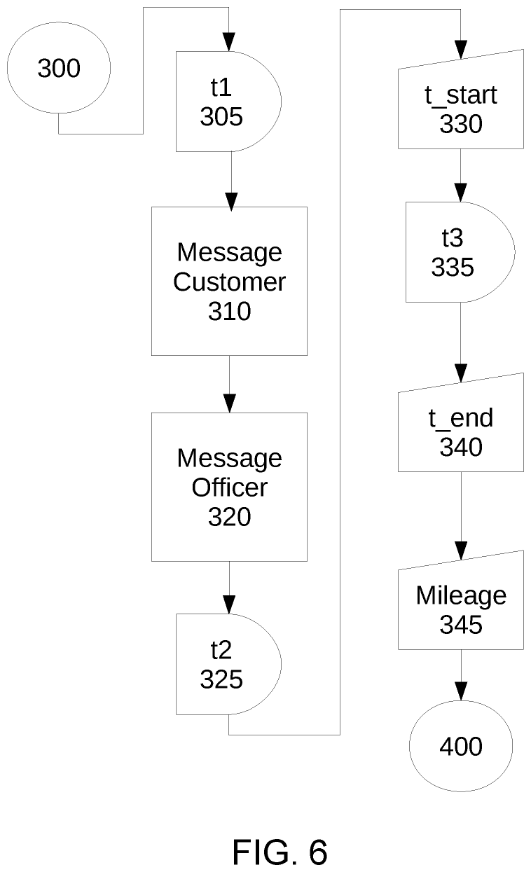

In step 270 the offer is communicated to the top candidate. If more than one officer is needed, the offer is communicated to the number of officers needed from the top of the candidate pool. The system may communicate the offer via network communication, such as by electronic mail or short message service (SMS). Each communicated offer conveys the details of the job, including the service to be provided, attire and vehicle information, date, location and time. The officer is given a limited time to accept the offer, otherwise the offer is deemed declined. The offer may include a URL or hyperlink for accepting or declining the offer. If an officer declines an offer, then step 275 directs control back to step 229 of FIG. 3. If time allows, the system will send the offer to the next candidate in the candidate pool. If the officer accepts the offer, then step 275 directs control to step 300 of FIG. 6.

FIG. 6 is a high level flowchart illustrating steps of an exemplary scheduling methodology for an exemplary system according to principles of the invention. The system will remind an officer who has accepted an offer of an upcoming job. In step 305, at a determined time (t1) before commencement of the job, the system sends a reminder communication to the customer 310 and to the officer 320. The reminder may contain a description of (or a link to a description of) the details of the job, attire, whether an official vehicle is required, and the date and times. The system may send the reminder to the officer (and a copy to the customer) by any form of electronic communication, including, but not limited to, electronic mail and text messaging via short message service (SMS).

As of the set start time (t2) 325 for the job, the hired officer may enter into the system a start entry 330. The start entry may be entered using an app on a smartphone or using a browser or dedicated application on a personal computer. The start entry is date and timestamped and associated with the records for the officer and job. Thus, the system prevents start entries before the scheduled time. This reduces risk of exceeding a budgeted amount for the job or employing an officer in excess of departmental limits.

After a start entry 330, the system continues to keep time 335 for the job, until the officer enters an end entry 340, signifying the conclusion of the job. By keeping time, the system may notify the officer at the scheduled end of the job. The system may send the notification to the officer by any form of electronic communication, including, but not limited to, electronic mail and text messaging via short message service (SMS). The notification may include a control or hyperlink for entering the end entry 340. The notification may inform the officer that if an end entry is not entered within a determined time after the notification (e.g., 5 minutes), the system will enter apply the scheduled end time as the end entry. The system may also notify the officer than any overtime beyond a determined time (e.g., 5 minutes) requires customer approval. The notification may include a control or link for requesting such customer approval. The end entry is date and timestamped and associated with the records for the officer and job. Thus, the system reduces risk of end entries appreciably after a scheduled time. This reduces risk of exceeding a budgeted amount for the job or employing an officer in excess of departmental limits.

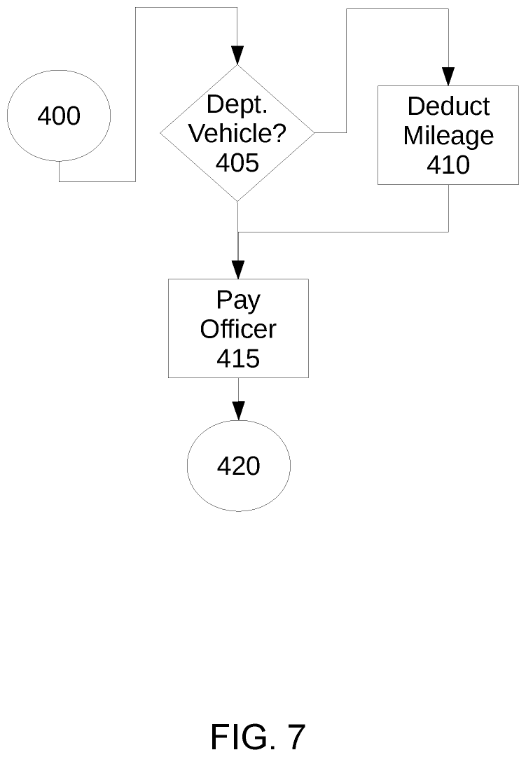

The notification provided at the end of the job may also include a link or control for entering other relevant information, such as mileage 345. Such information may be used to compute additional fees, such as fees related to use of an official vehicle on the job. After the time entries, control passes to step 400 of FIG. 7.

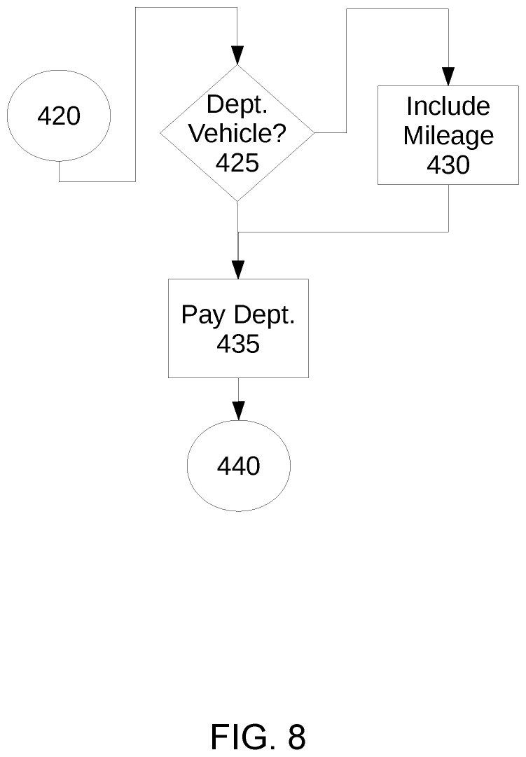

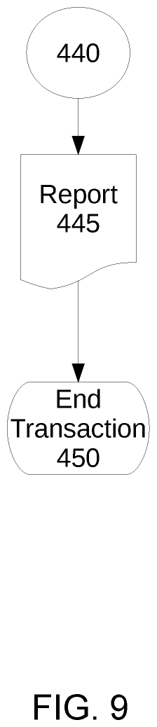

FIGS. 7 and 8 are high level flowcharts illustrating steps of an exemplary payment methodology for an exemplary system according to principles of the invention. If a department vehicle is used for the job, as determined in step 405, payment for use of the vehicle, such as payment for mileage, is excluded or deducted 410 from the amount to be paid to the officer 415. Control then proceeds to 420 of FIG. 8. If a department vehicle was used 425, then a fee for use of the vehicle, such as a fee based upon mileage 430, is included in any amount paid to the department 435. Then control passes to step 440 of FIG. 9.

FIG. 9 is a high level flowchart illustrating steps of reporting for an exemplary system according to principles of the invention. The system may generate one or more reports for completed jobs, as in step 445. A report takes data from a source, such as a database 160, and uses it to produce a document in a determined format. A report may be produced for each officer, each customer and each department. A report for an officer may contain data for each job performed by the officer or for jobs performed by the officer in a determined period of time (e.g., monthly, quarterly, annually). A report for a customer may contain data for each job performed for the customer or for jobs performed for the customer in a determined period of time (e.g., monthly, quarterly, annually). A report for a department may contain data for each job performed by an officer of the department or for jobs performed by officers of the department in a determined period of time (e.g., monthly, quarterly, annually).

After reporting, the exemplary method concludes 450. The method may be repeated for each job and each customer. Multiple occurrences may be performed simultaneously from the same or separate servers

While an exemplary embodiment of the invention has been described, it should be apparent that modifications and variations thereto are possible, all of which fall within the true spirit and scope of the invention. With respect to the above description then, it is to be realized that the optimum relationships for the components and steps of the invention, including variations in order, form, content, function and manner of operation, are deemed readily apparent and obvious to one skilled in the art, and all equivalent relationships to those illustrated in the drawings and described in the specification are intended to be encompassed by the present invention. The above description and drawings are illustrative of modifications that can be made without departing from the present invention, the scope of which is to be limited only by the following claims. Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents are intended to fall within the scope of the invention as claimed.

What is claimed is:

1. A computer implemented method for managing off-duty jobs for officers, said method comprising:
receiving on a first computing system, from a second computing device, a job posting for an off-duty job from a customer;
upon receiving the job posting, the first computing system automatically accessing a database, the database containing a plurality of records, the plurality of records including a record for each officer eligible for off-duty work;
after accessing the database, the first computing system automatically applying a first filter to exclude at least one record for an officer eligible for off-duty work, each of the excluded at least one record being an excluded record;
the first computing system automatically applying a multi-level sort to sort the plurality of records, excluding each excluded record, in a determined order, the determined order spanning in progression from a first record for an officer eligible for off-duty work, to a last record for another officer eligible for off-duty work; and
the first computing system automatically communicating, via network communication, to a third computing device, an invitation to the officer eligible for off-duty work corresponding to the first record, the invitation being an invitation to perform the off-duty job.

2. The computer implemented method of claim 1, each record of the plurality of records including a plurality of fields, the plurality of fields including:
an identifier for an officer eligible for off-duty work,
a rank for the officer eligible for off-duty work, a seniority indicator for the officer eligible for off-duty work,
a total hours worked quantity for off-duty jobs worked by the officer eligible for off-duty work during a determined period of time, and
an indicator of the time to a preceding off-duty job worked by the officer eligible for off-duty work.

3. The computer implemented method of claim 2, the step of automatically applying a first filter comprising automatically applying a first filter to exclude each record that includes at least one of the following fields:
the rank being a determined rank,
the total hours worked quantity not being less than a determined limit, and
the indicator of the time to a preceding off-duty job worked by the officer eligible for off-duty work not being greater than a determined limit.

4. The computer implemented method of claim 2, the step of automatically applying a multi-level sort comprising automatically sorting records by at least two sort levels, the two sort levels including two of the following:
the rank,
the total hours worked quantity, and
the indicator of the time to a preceding off-duty job worked by the officer eligible for off-duty work.

5. The computer implemented method of claim 2, the step of automatically applying a multi-level sort comprising automatically sorting records by at least three sort levels, the three sort levels including the following:
the rank,
the total hours worked quantity, and
the indicator of the time to a preceding off-duty job worked by the officer eligible for off-duty work.

6. The computer implemented method of claim 2, the step of automatically applying a multi-level sort comprising automatically sorting records by at least two sort levels, the two sort levels including the following:
the rank sorted in descending order,
the total hours worked quantity sorted in ascending order, and
the indicator of the time to a preceding off-duty job worked by the officer eligible for off-duty work sorted in descending order.

7. The computer implemented method of claim 2, the step of automatically applying a multi-level sort comprising automatically sorting records by at least three sort levels, the three sort levels including the following:
the rank sorted in descending order,
the total hours worked quantity sorted in ascending order, and
the indicator of the time to a preceding off-duty job worked by the officer eligible for off-duty work sorted in descending order.

8. The computer implemented method of claim 2, the step of automatically applying a multi-level sort comprising automatically sorting records by at least three sort levels, the three sort levels including the following sorts in the an order determined by input from the second computing device:
first, the rank sorted in descending order,
second, the total hours worked quantity sorted in ascending order, and
third, the indicator of the time to a preceding off-duty job worked by the officer eligible for off-duty work sorted in descending order.

9. The computer implemented method of claim 2, the step of automatically applying a multi-level sort comprising automatically sorting records by at least three sort levels, the three sort levels including the following sorts in the following order:
first, the indicator of the time to a preceding off-duty job worked by the officer eligible for off-duty work sorted in descending order;
second, the total hours worked quantity sorted in ascending order; and
third, the rank sorted in descending order.

10. The computer implemented method of claim 1, further comprising the first computing system receiving via network communication from the third computing device a reply to the invitation to the officer eligible for off-duty work corresponding to the first record.

11. The computer implemented method of claim 10, the reply comprising an acceptance and the method further comprising a step of the first computing system delaying for a determined period of time after the first computing system receives the reply, and then communicating to the third computing device a reminder of the off-duty job.

12. The computer implemented method of claim 10, the reply comprising a rejection and the method further comprising a step of the first computing system automatically communicating, via network communication, to a fourth computing device, an invitation to the officer eligible for off-duty work corresponding to a second record for an officer eligible for off-duty work, the invitation being an invitation to perform the off-duty job.

13. The computer implemented method of claim 1, further comprising a step of the first computing system delaying a determined time period after communicating the invitation, and if the first computing system has not received from the third computing device a reply to the invitation by the end of the delay, then the first computing system automatically communicating, via network communication, to a fourth computing device, an invitation to the officer eligible for off-duty work corresponding to a second record for an officer eligible for off-duty work, the invitation being an invitation to perform the off-duty job.

14. The computer implemented method of claim 1, further comprising a step of the first computing system automatically receiving, via network communication, from the third computing device, a start communication from the officer eligible for off-duty work corresponding to the first record, the start communication being time stamped and indicating that the officer has begun to perform the off-duty job.

15. The computer implemented method of claim 14, further comprising a step of the first computing system automatically receiving, via network communication, from the third computing device, an end communication from the officer eligible for off-duty work corresponding to the first record, the end communication being time stamped and indicating that the officer has ceased to perform the off-duty job.

16. The computer implemented method of claim 15, further comprising a step of the first computing system automatically determining, based upon the start communication and the end communication, a payment amount to the officer for the officer performing the off-duty job.

17. The computer implemented method of claim 15, further comprising a step of the first computing system automatically determining, based upon the start communication and the end communication, a payment amount to a department employing the officer for the officer performing the off-duty job.

18. The computer implemented method of claim 15, the off-duty job requiring use of an official department vehicle and the method further comprising a step of the first computing system automatically determining a payment amount to a department employing the officer for use of the official department vehicle.

19. The computer implemented method of claim 15, further comprising a step of the first computing system automatically communicating a first report to the third computing device.

20. The computer implemented method of claim 19, further comprising a step of the first computing system automatically communicating a second report to a fifth computing device of a department employing the officer.
